(19) United States
(12) Patent Application Publication
(10) Pub. No.: US 2006/0234542 A1
(43) Pub. Date: Oct. 19, 2006

(54) Electrical connector assembly

(75) Inventor: David (Tso-Chin) Ko, Fullerton, CA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/110,335

(22) Filed: Apr. 19, 2005

(51) Int. Cl. H01R 12/24

(52) U.S. Cl. 439/495

(57) ABSTRACT

An electrical connector assembly (100) includes a first connector (200), a second connector (500) and an insulative base housing (1). The first connector includes a first housing (30) and a number of first terminals (20) fitted in and outwardly projecting from one end of the housing. The second connector has a second insulative housing (31) and a number of second terminals (21) fitted in and extending beyond one end of the second housing. The base housing includes a first holding portion for supporting the first connector and a second holding portion for supporting the second connector. The base housing defines an accessible mating interface (10) having a number of passages (122) are arranged in a first row and a second row to respectively dispose the first terminals and the second terminals.

### BACKGROUND OF THE INVENTION

1. Field of the Invention

The present invention generally relates to an electrical connector assembly, and more particularly to a Flat Flexible Cable (FFC) connector assembly.

2. Description of Related Art

Flat Flexible Cables (FFC) are widely used to connect components, such as a printed circuit board, arranged in a confined space inside an electronic device, such as a computer, for deducing the overall size of the electronic device. A conventional FFC connector usually comprises an insulative housing defining a receiving cavity for movably receiving an actuator. The actuator has a tongue insertable into the receiving cavity and a top face for retaining a leading end of a flat flexible cable, whereby, when the tongue is inserted into the cavity, the flat flexible cable engaged with rear cantilevered arms of electrical contacts accommodated in the receiving cavity. Moreover, each contact comprises forward cantilevered arms opposite to the rear arms for electrically connecting with terminals of a complementary connector, which is mounted on a printed circuit board, so as to established electrical connection between two electronic devices. For this reason, the contact of the FFC connector has a relative complicated structure, which is difficult to be fabricated and assembled. Accordingly, the FFC connector is designed to have a relative large overall dimension for disposing the contacts with complicated structure and the actuator therein. However, when it is required two or more FFCs to the printed circuit board, a corresponding number of connectors are needed, and thus, occupy more space on the printed circuit board.

Hence, an improved FFC connector assembly is needed to overcome the disadvantages of the related art.

### SUMMARY OF THE INVENTION

Accordingly, an object of the present invention is to provide an electrical connector assembly adapted for connecting two or more flexible flat cables as well as maintaining a low profile.

In order to achieve the object set forth, an electrical connector assembly in accordance with present invention comprises a first connector having a first insulative housing, second connector and an insulative base housing. The first connector comprises a first housing and a plurality of first terminals fitted in and outwardly projecting from one end of the housing. The second connector has a second insulative housing and a plurality of second terminals fitted in and extending beyond one end of the second housing. The base housing comprises a first holding portion for supporting the first connector and a second holding portion for supporting the second connector. The base housing defines an accessible mating interface having a plurality of passages are arranged in a first row and a second row to respectively dispose the first terminals and the second terminals.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of an electrical connector assembly in accordance with the present invention;

FIG. 2 is an assembled, perspective view of a cable assembly without a cover shown in FIG. 1;

FIG. 3 is a view similar to FIG. 2, but taken from a different aspect;

FIG. 4 is an exploded, perspective view of the cable assembly shown in FIG. 2

FIG. 5 is a view similar to FIG. 4, but taken from a different aspect;

FIG. 6 is a partially assembled, perspective view of a first connector shown in FIG. 5;

FIG. 7 is a cross-sectional view of FIG. 2 taken along line 7-7; and

FIG. 8 is a cross-sectional view of FIG. 3 taken along line 8-8.

### DETAILED DESCRIPTION OF THE INVENTION

Reference will now be made in detail to the preferred embodiment of the present invention.

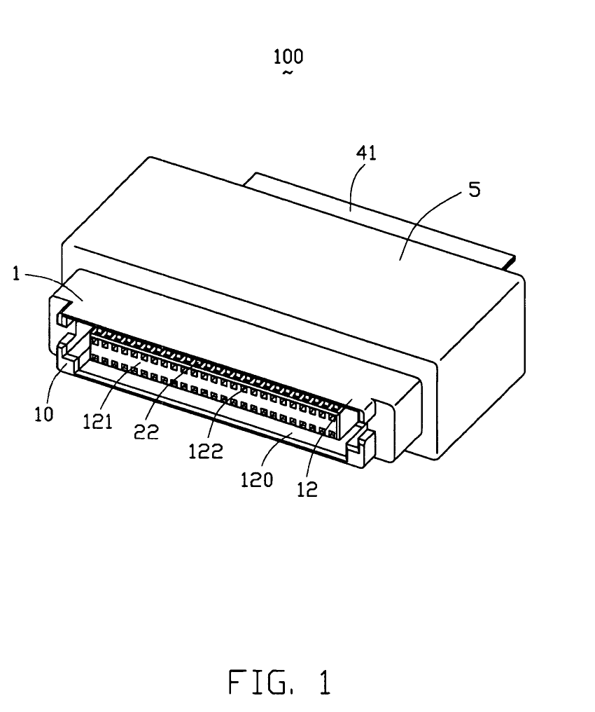

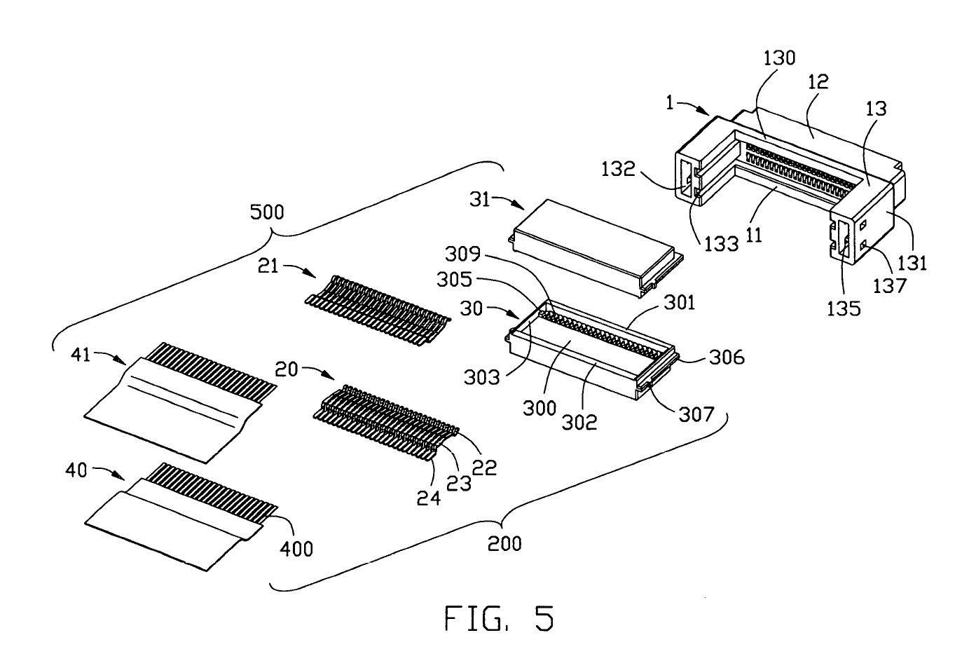

Referring to FIG. 1 and FIG. 5, an electrical connector assembly 100 in accordance with the present invention comprises a bracket-shape insulative base housing 1, a first connector 200 and a second connector 500, both of which are assembled to the base housing 1.

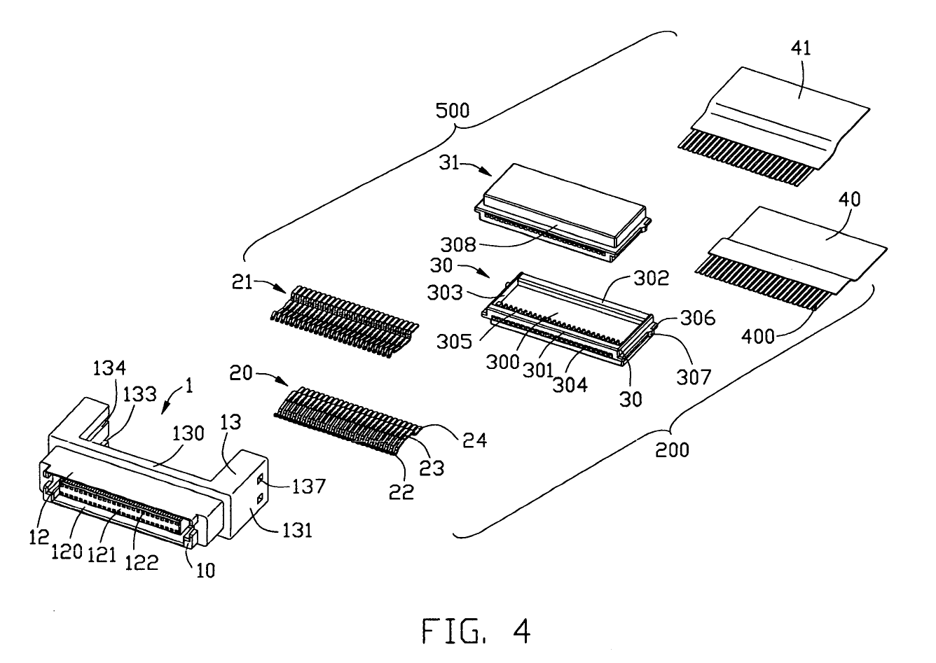

Referring to FIG. 4 and FIG. 5, the base housing 1 comprises a rectangular mating portion 12 defining a mating interface 10 of the connector assembly 100 and an U-shape engaging portion 13 extending rearwardly from the mating portion 12 and comprising a first holding portion (not labeled) and a second holding portion (not labeled). The mating interface 10 is defined by a receiving cavity 120 for receiving a portion of a complementary connector (not shown) and a tongue board 121 formed in the center of the receiving cavity 120. The tongue board 121 defines a plurality of passages 122 extending therethrough. The passages 122 are arranged in an upper row and a lower row in a lengthwise direction of the tongue board 121. The engaging portion 13 comprises an outward flange 130 surrounding the mating portion 12 and a pair of arm portions 131 rearwardly extending from two opposite ends of the outward flange 130. A rear face of the outward flange 130 is defined as a connection face 111 of the base housing 1. The arm portions 131 define a pair of opposite first channels 133 in inner side surface thereof and a pair of second channels 134 respectively located above the first channels 133. Each arm portion 131 further defines a rear opened slot 132, a first aperture 135 in communication with corresponding first channel 133 and the slot 132, a second apertures (not labeled) in communication with corresponding second channels 134, and a pair of third apertures 137 in out side surface in communication with the slot 132.

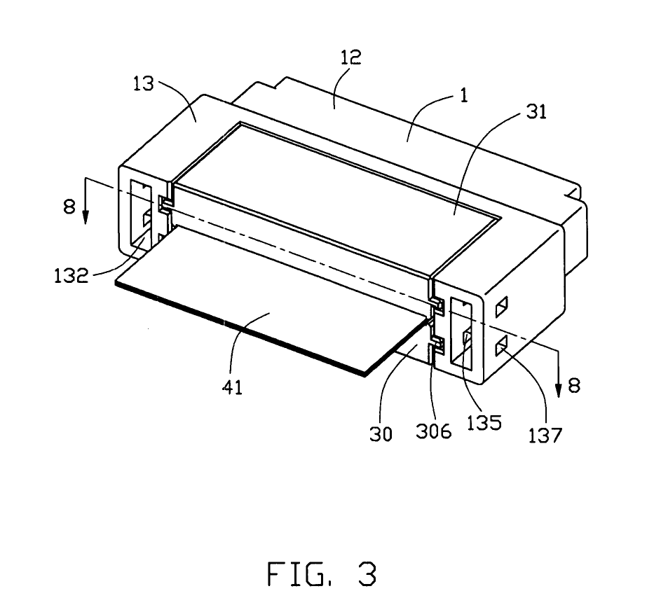

Referring to FIGS. 3-5, as the first connector 200 and the second connector 500 are designed in the substantially same structure in the preferred embodiment, only the first connector 200 will be described in great detail hereafter. The first connector 200 comprises a block shape insulated first housing 30, a set of first terminals 20 assembled to the first housing 30 and a flat flexible first cable 40 solderable to the first terminals 20. Each first terminal 20 comprises a contacting portion 22, an opposite tail portion 24 and a retaining portion 23 with barbs (not labeled) thereon located between the contacting portion 22 and the tail portion 24. The first housing 30 forms a front flange 301, a rear flange 302 and a pair of side flanges 303 extending between the front and the rear flanges 301, 302, the front, rear and side ranges 301, 302, 303 together define a depression 300 on one side thereof. The front flange 301 defines a plurality of through holes 304 respectively in alignment with corresponding rear openings (not labeled) of the passages 122 of the lower row of the base housing 1. A plurality of partition portions 305 are formed on a bottom surface of the depression 300. A spare space 309 is provided between the front flange 301 and front ends of the partition portions 305 for receiving the first terminals 20 and the first cable 40. A pair of positioning portions 306 are formed on opposite lateral sides of the first housing 30, each of which has an outwardly protruding protrusion 307 at a rear portion thereof. A stepped portion 308 is formed at the front end of the first housing 30 below the through holes 304. The first terminals 20 are assembled to the first housing 30, with the tail portions 24 passing through corresponding through holes 304 and received in the spare space 309, and with the retaining portions 23 and the contact portions 22 extending beyond the front end of the first housing 30. The first cable 40 comprises a plurality of conductors 400, moreover, front portions of the conductors 400 are exposed for later soldering process. A front portion of the first cable 40 is fittingly fitted in the depression 300, the exposed conductors 400 are respectively laid on corresponding tail portions 24 of the first terminals 20 and separated from each other by the partition portions 305. The first terminals 20 and the conductors 400 of the first cable 40 are then aligned in the spare space 309 and soldered together by hot bar process with good soldering quality. The second connector 500 comprises an insulative second housing 31, a set of second terminals 21 fixed to the second housing 31 and a second flat flexible cable 41 soldered to the second terminals 21.

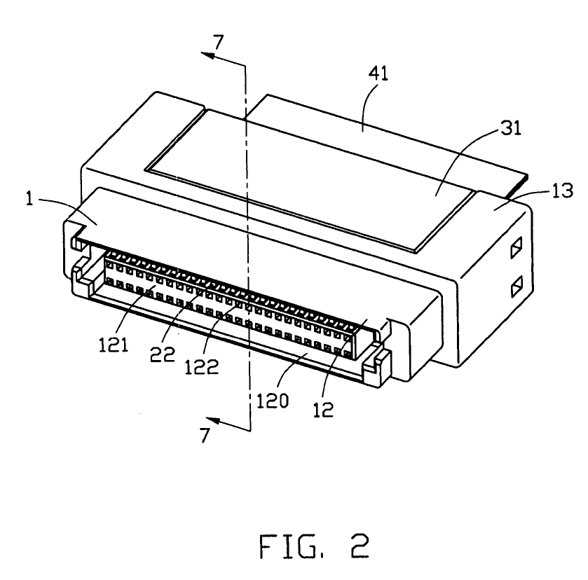

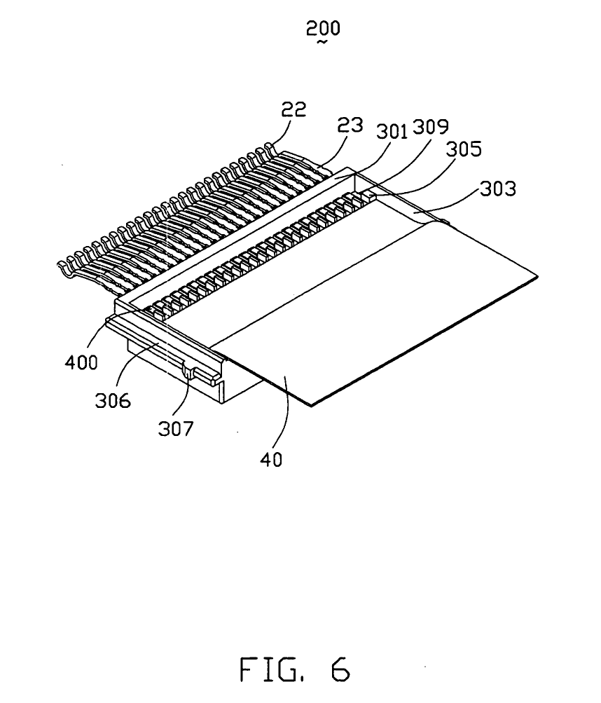

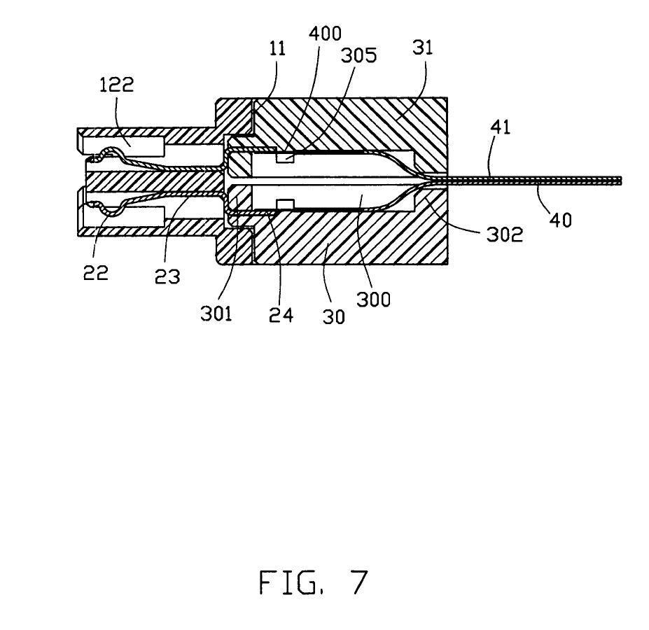

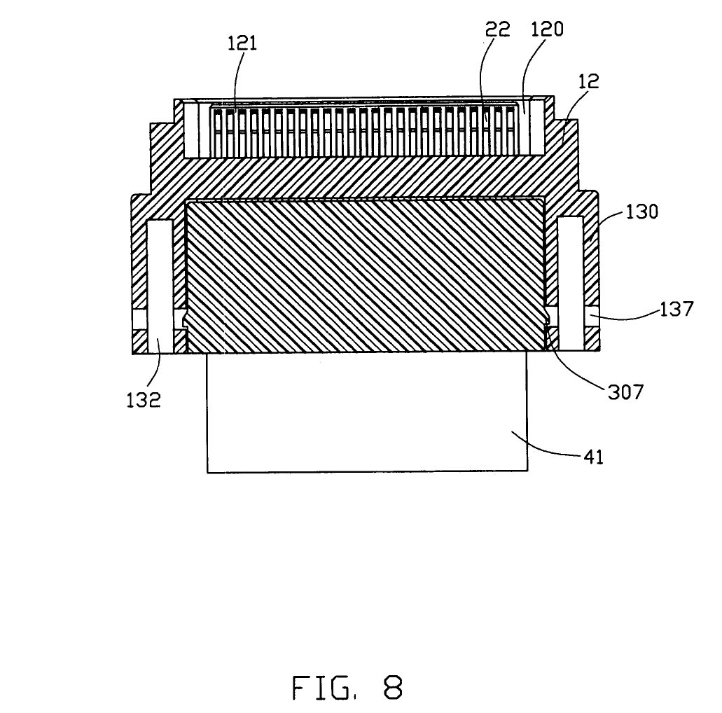

Referring to FIGS. 1-3 and FIGS. 4-8, the first and the second connectors 200, 500 are assembled to the base housing 1 from a rear side in a mirror-image disposition relative to a line between the first connector 200 and the second connector 500. The positioning portions 306 of the first connector 200 are fittingly inserted into the first channels 133 with the protrusions 307 sliding into the first apertures 135 so as to prevent the first and the second connectors 200, 500 from rearward/frontward moving relative to the base housing 1. In this view, the pair of first channels 133 are functioned as the first holding portion for supporting the first connector 200, and the pair of second channels 134 are functioned as the second holding portion for holding the second connector 500. The set of first terminals 20 and the set of the second terminals 21 are respectively inserted into corresponding passages 122 in the lower and upper rows with the contacting portions 22 exposed into the receiving cavity 120 to electrically contacting with contact portions (not shown) of the complementary connector. Thus, the rear openings of passages 122 are substantially sealed by the first and the second terminals 20, 21 and the front flanges 301 of the first and second housings 30, 31. The stepped portions 308 of the first housing 30 and the second housing 31 are intimately in contact with the rear face 11 of the base housing 1. Further, in preferred embodiment of the present invention, the portions exposed outside the first housing 30 and the second housing 31 of the first and the second cables 40, 41 are aligned in a line to be laminated and bonded in one. An insulated cover 5 is then provided for molding over the engaging portion 13 of the base housing 1, the first connector 200 and the second connector 500 with the two in one cable 4 exposed. During molding process of the cover 5, melted insulated material flows into the slots 132 of the base housing 1 so that the cover 5 is reliably engaged with the base housing 1 when the insulated material is cooled.

In other embodiments of the present invention, the first connector 200 and the second connector 500 could have different structures for meeting demands of various applications. In addition, the first and the second terminals 20, 21 can be electrically connected to other connecting member, e.g. flexible printed circuit, printed circuit board or common cables, in permanently/impermanently connection manners. Besides, although the first and the second holding portions of the base housing 1 in preferred embodiment is formed by the spaced first and second channels, the first and the second holding portions could be configured in other structures whichever can position/hold the first and the second connectors 200, 500.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical connector assembly, comprising:
a first connector having a first insulative housing with a depression on a lower surface, a plurality of first terminals fitted in and outwardly projecting from one end of the housing;
a second connector having a second insulative housing with a depression on an upper surface thereof facing to the depression of the first connector, a plurality of second terminals fitted in and extending beyond one end of the second housing;
two sheet-like cables, respectively, with front portions together fitted in corresponding depressions of the first and the second connectors to electrically connect with the first and second terminals respectively; and
an insulative base housing comprising a first holding portion for supporting the first connector and a second holding portion for supporting the second connector, the base housing defining an accessible mating interface having a plurality of passages arranged in a first row and a second row to respectively dispose the first terminals and the second terminals therein.

2. The electrical connector assembly as claimed in claim 1, wherein the first connector and the second connector are assembled to the base housing in a mirror-image disposition relative to a line between the first connector and the second connector.

3. The electrical connector assembly as claimed in claim 1, wherein the first housing and the second housing both have positioning portions thereon for engaging with the first holding portion and the second holding portion so as to fix the first connector and the second connector to the base housing.

4. The electrical connector assembly as claimed in claim 3, wherein the base housing comprises a pair of arms behind the mating interface, the first holding portion is formed by a pair of rear-to-front first channels in inner surface of the arms and the second holding portion is formed by a pair of second channels located above the first channels, and wherein the positioning portions of the first connector and the second connector are respectively received in the first channels and the second channels.

5. The electrical connector assembly as claimed in claim 4, wherein each arm portion defines a first aperture in communication with the first channel and a second aperture in communicating with the second channel, and wherein each positioning portion has a protrusion thereon for engaging with corresponding first and second apertures to prevent the first and second connectors from the movement relative to the base housing.

6. (canceled)

7. The electrical connector assembly as claimed in claim 1, wherein the sheet-like cables of the first and the second connectors are flexible and flat-shaped.

8. The electrical connector assembly as claimed in claim 1, wherein portions exposed outside the first housing and the second housing of each cable are essentially closely attached to each other as a unitary piece.

9. The electrical connector assembly as claimed in claim 1, wherein the first housing and the second housing both have a plurality of partition portions thereon for spacing the conductors of the cable from each other.

10. The electrical connector assembly as claimed in claim 9, wherein the first housing and the second housing both comprises a front flange, an opposite rear flange, and a pair of side flanges extending between the front flange and the second flange, the front, rear and side flanges together define a depression on one side thereof for aligning the cables of the first and the second connectors, and wherein the partition portions are formed on bottom faces of the depressions.

11. The electrical connector assembly as claimed in claim 9, wherein each of the first terminals and the second terminals comprises a contacting portion and an opposite tail portion, and wherein each of the first housing and the second housing defines a spare space between front ends of the partition portions and the front flange for receiving tail portions of the first and the second terminals and front portions of the conductors of the cable laid on corresponding tail portions therein.

12. The electrical connector assembly as claimed in claim 1, wherein the first housing and the second housing both define a plurality of through holes at a front end thereof respectively in correspondence with the passages for permitting the first terminals and the second terminals to pass through.

13. The electrical connector assembly as claimed in claim 1, wherein the base housing comprises a receiving cavity for receiving corresponding portion of a complementary connector and a tongue board formed in the center of the receiving cavity, and wherein the passages are defined through the tongue board.

14. The electrical connector assembly as claimed in claim 1 further comprising an insulative cover partially molded over the base housing, the first connector and the second connector.

15. An electrical connector assembly, comprising:
an insulative base housing comprising a holding portion, the base housing defining an accessible mating interface having a plurality of passages arranged in a row;
a connector module having an insulative housing defining a plurality of partitions forming a plurality of holes each located between every adjacent two partitions, a plurality of terminals respectively fitted in the corresponding through holes and outwardly projecting from one end of the housing and into the corresponding passages which is aligned with the corresponding through holes in front-to-back direction, respectively; and
a flat flexible cable including a plurality of wires respectively electrically and mechanically connected to the corresponding terminals; wherein
said flat flexible cable and said connector module are horizontally assembled to the base.

16. The electrical connector assembly as claimed in claim 15, wherein the wires are connected to the corresponding terminals in the connector module.

17. An electrical connector assembly comprising:
an insulative housing defining two rows of passageways,
two rows of terminals disposed in the corresponding passageways, said terminals defining mounting portions, respectively, in a rear side of the housing;
the mounting portions of the terminals in one row being spatially opposite to those in the other row;
two sheet-like cables each including a plurality of wires defining front portions respectively connected to the corresponding mounting portions; and
other portions of said two cables being essentially closely attached to each other as a unitary piece.

18. The electrical connector assembly as claimed in claim 17, wherein said two sheet-like cables are arranged in an mirror-image manner with each other with regard to the housing.

19. The electrical connector assembly as claimed in claim 1, further comprising a cover enclosing the first and the second connector, and the base housing.

20. The electrical connector assembly as claimed in claim 17, further comprising a cover enclosing the first and the second connector, and the base housing.
